(19) United States
(12) Patent Application Publication
(10) Pub. No.: US 2004/0107209 A1
(43) Pub. Date: Jun. 3, 2004

(54) Hierarchical structure display apparatus and method

(75) Inventors: Noriko Minamino, Tokyo (JP); Yumiko Mizoguchi, Kanagawa-ken (JP); Hiroshi Murayama, Kanagawa-ken (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA

(21) Appl. No.: 10/717,707

(22) Filed: Nov. 21, 2003

(30) Foreign Application Priority Data
Nov. 22, 2002 (JP) P2002-340041

(51) Int. Cl. G06F 7/00

(52) U.S. Cl. 707/102

(57) ABSTRACT

A memory stores a database for a plurality of classes having a hierarchical structure. A display outputs at least part of a first area of one class and at least part of a second area of at least one child class belonging to the one class. The one class and the at least one child class are defined in the plurality of classes of the database. The first area includes the second area on the display.

### CROSS-REFERENCE TO RELATED APPLICATIONS

This application is based upon and claims the benefit of priority from the prior Japanese Patent Application P2002-340041, filed on Nov. 22, 2002; the entire contents of which are incorporated herein by reference.

### FIELD OF THE INVENTION

The present invention relates to a hierarchical structure display apparatus and a method for effectively displaying a hierarchical structure of a plurality of classes stored in a hierarchical type database.

### BACKGROUND OF THE INVENTION

Recently, a technical area of a computer software is progressing in order to present a user friendly function. For example, in the case of utilizing a file system, a user often moves a cursor to his/her desired directory and opens this directory. In order for the user to visually and intuitively execute this operation, a graphic user interface (GUI) displays a directory structure (folder) by combining a line, an icon and so on, and presents this directory structure to the user. Such GUI function is widely used in an operating system (OS) “Windows” (Microsoft Corporation) and a general purpose operating system such an “UNIX” or “LIUNIX”.

As to each node in a directory structure tree, a relationship of an inclusion or a subset does not exist between information of a high level (high rank) node and information of a low level (low rank) node. Briefly, each node starting from a root node and forming the directory structure tree represents a mutual connection relationship of a container storing information such as a file.

On the other hand, in an object oriented database (OODB) or an object relational database (ORDB), a hierarchical structure for a plurality of classes exists and a low level class inherits a property of a high level class. In this database, a property of the low level class increases because it inherits a property of the high level class. Inheriting a property of the high level class for the low level class is called “inheritance”. This technique is disclosed in the following documents.

Object-Oriented Concepts, Databases, and Applications, Edited by Won Kim, 1989, ACM Press

In a technical area of the object oriented database (OODB), classification in the hierarchy is often called “class”. In this specification, a meaning of “classification” is almost same as a meaning of “class”. Furthermore, in the object relational database (ORDB), a table to permit the inheritance of the property corresponds to a class. In a plurality of tables from a high level to a low level, a property is inherited from a table of the high level to a table of the low level. In ORDB, the property corresponds to header information of a column forming the high level table. This property is inherited to the low level table.

In this specification, the object oriented database (OODB) and the object relational database (ORDB) are called “hierarchical type database”. Furthermore, concrete data of the same property of the class belonging to each hierarchy is called “instance”, and a set of the instance is called “population” of the data.

In this way, a hierarchical structure of the hierarchical type database includes an inclusion relationship (inheritance relationship) between classes. Accordingly, characteristic of the hierarchical structure is apparently different from above-mentioned directory structure tree. Several services of a product catalogue database to which the hierarchical type database is applied is already presented as shown in following two documents.

Portal Corporation,

Internet <URL:http://www.portalcorp.net>

e-ingBiz.com,

Internet (URL:http://www.e-ingbiz.com//CATALOG2/servlet/CatalogSearch?Lang=ja>

As to a hierarchical structure display, in a display structure tree, for example, in Explorer of Microsoft Corporation, the following display method is applied.

A folder (directory) of the low level is expansibly displayed-by a request of open and shut for a folder of the high level.

A head position of the folder of the low level is displayed at a lower position from a head position of the folder of the high level.

Each head position of the folders of the same hierarchical level is displayed at the same position.

By watching this hierarchical structure display, the user can trace a connection relationship only among nodes (directories). Accordingly, such hierarchical structure display is not suitable for the hierarchical type database in which a property is inherited from the high level class to the low level class.

As to a display of hierarchical structure in the hierarchical type database, in the case that each class represents a concept characterized by its property, inclusion relationship between classes should be represented. Furthermore, in the case that a hierarchical structure of the hierarchical type database is composed by each class, existence (or non-existence) of the instance of each class should be displayed.

### SUMMARY OF THE INVENTION

The present invention is directing to a hierarchical structure display apparatus and a method for effectively displaying an inclusion relationship between classes in the hierarchical type database.

According to an aspect of the present invention, there is provided an apparatus for displaying a hierarchical structure, comprising: a memory configured to store a database for a plurality of classes having a hierarchical structure; and a display configured to output at least part of a first area of one class and at least part of a second area of at least one child class belonging to the one class, the one class and the at least one child class being defined in the plurality of classes, and the first area including the second area.

According to another aspect of the present invention, there is also provided a method for displaying a hierarchical structure comprising: storing a database for a plurality of classes having a hierarchical structure; and displaying at least part of a first area of one class and at least part of a second area of at least one child class belonging to the one class, the one class and the at least one child class being defined in the plurality of classes, and the first area including the second area.

According to still another aspect of the present invention, there is also provided a computer program product, comprising: a computer readable program code embodied in said product for causing a computer to display a hierarchical structure, said computer readable program code comprising: a first program code to store a database for a plurality of classes having a hierarchical structure; and a second program code to display at least part of a first area of one class and at least part of a second area of at least one child belonging to the one class, the one class and the at least one child class being defined in the plurality of classes, and the first area including the second area.

### BRIEF DESCRIPTION OF THE DRAWINGS

FIG. 1 is a block diagram of the hierarchical structure display apparatus according to one embodiment of the present invention.

FIG. 2 is a schematic diagram of inclusion relationship between classes according to one embodiment of the present invention.

FIG. 3 is a flow chart of a decision processing of existence of the instance in the low level class according to one embodiment of the present invention.

FIG. 4 is a schematic diagram of one example of a GUI screen related to the hierarchical structure display according to one embodiment of the present invention.

FIG. 5 is a schematic diagram of one example of property information by a property information display according to one embodiment of the present invention.

FIG. 6 is a schematic diagram of one example of a heritage display according to one embodiment of the present invention.

FIG. 7 is a schematic diagram of one example of traversal retrieval according to one embodiment of the present invention.

FIG. 8 is a flow chart of a set processing of a retrieval start point according to one embodiment of the present invention.

FIG. 9 is a schematic diagram of one example of the hierarchical structure including multi-inheritance according to one embodiment of the present invention.

FIG. 10 is a schematic diagram of one display example of partial inheritance of the hierarchical structure according to one embodiment of the present invention.

FIG. 11 is a schematic diagram of another display example of partial inheritance of the hierarchical structure according to one embodiment of the present invention.

FIG. 12 is a schematic diagram of one example of the same color display of a class and its property according to one embodiment of the present invention.

FIG. 13 is a schematic diagram of one example of reference display of a partial inherited property from an inheritance destination class to an inheritance source class according to one embodiment of the present invention.

FIG. 14 is a schematic diagram of one display example of a virtual root by a hierarchical structure display according to one embodiment of the present invention.

FIG. 15 is a schematic diagram of one display example of an initial set of the virtual root according to one embodiment of the present invention.

FIG. 16 is a schematic diagram of a set example of an initial expansion class according to one embodiment of the present invention.

### DETAILED DESCRIPTION OF THE EMBODIMENTS

Hereinafter, various embodiments of the present invention will be explained by referring to the drawings.

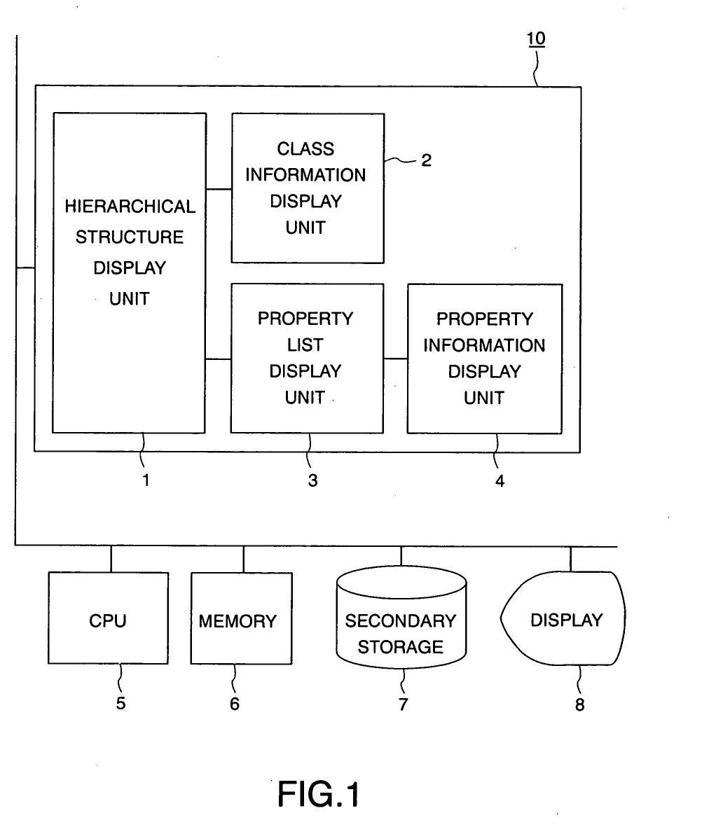

FIG. 1 is a block diagram of general components of a hierarchical structure display system according to one embodiment of the present invention. In this system, based on a hierarchical structure display of the hierarchical type database, a user can easily execute retrieval and database management irrespective of a scale and a detail degree of the database.

By using a general purpose computer having basic hardware such as a CPU 5, a memory 6, a secondary storage 7 and a display 8, the hierarchical structure display apparatus of the present invention can be realized as an application program 10 which operates on the general purpose computer. In this case, an execution environment of the application program 10 is presented, and an operating system to control the hardware is introduced to the general purpose computer. The application program 10 of the hierarchical structure display apparatus is loaded onto the operating system and composes a graphical user interface (GUI) cooperating with the display 8, a mouse, and a keyboard (not shown in FIG. 1). A hierarchical type database is, for example, introduced into the secondary storage 7. As shown in FIG. 1, the hierarchical structure display apparatus includes a hierarchical structure display unit 1, a class information display unit 2, a property list display unit 3, and a property information display unit 4.

As used herein, those skilled in the art will understand that the term “unit” is broadly defined as a processing device (such as a server, a computer, a microprocessor, a microcontroller, a specifically programmed logic circuit, an application specific integrated circuit, a discrete circuit, etc.) that provides the described communication and functionally desired. While such a hardware-based implementation is clearly described and contemplated, those skilled in the art will quickly recognize that a “unit” may alternatively be implemented as a software module that works in combination with such a processing device.

Depending on the implementation constraints, such a software module or processing device may be used to implement more than one “unit” as disclosed and described herein. Those skilled in the art will be familiar with particular and conventional hardware suitable for use when implementing an embodiment of the present invention with a computer or other processing device. Likewise, those skilled in the art will be familiar with the availability of different kinds of software and programming approaches suitable for implementing one or more “units” as one or more software modules.

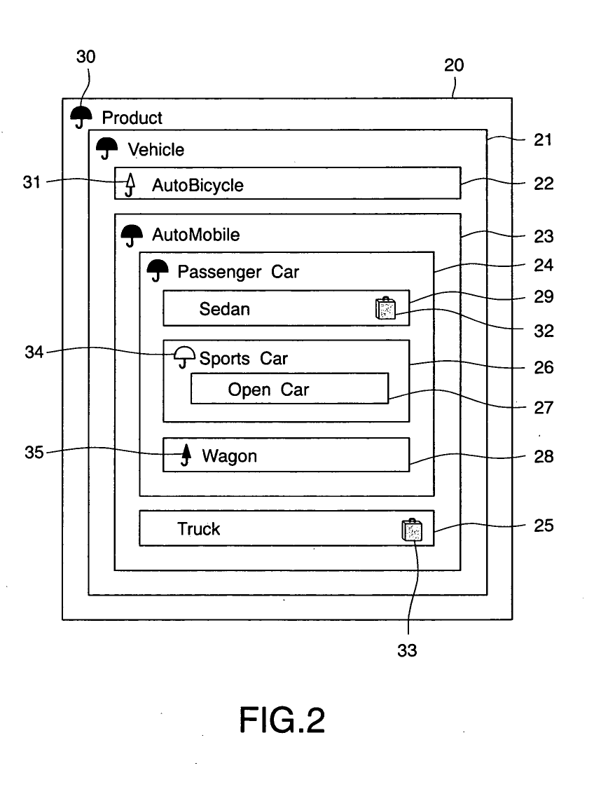

In the hierarchical type database in which a property is inherited from a high level class to a low level class such as “ISO 135841”, as a hierarchical relationship between a high level and a low level, inclusion relationship of the hierarchical structure is easy for a user to understand a relationship between classes. Accordingly, as shown in FIG. 2, the hierarchical structure display unit 1 explicitly displays inclusion relationships between classes. In this example, each class is displayed using a rectangular diagram so that a high level class includes a low level class. In FIG. 2, a “Product” class 20 includes a “Vehicle” class 21. It is apparent that the “Vehicle” class 21 includes an “AutoBicycle” class 22 and an “AutoMobile” class 23. In other words, the “AutoBicycle” class 22 and the “AutoMobile” class 23 are included in the “Vehicle” class 21. Furthermore, the “AutoMobile” class 23 includes a “Passenger Car” class 24 and a “Truck” class 25.

A display of inclusion relationship using such rectangular diagram can be transformed as follows. For example, a part of the diagram 20 representing the inclusion relationship shown in FIG. 2 (i.e., an edge part of the right side of the diagram 20 or an edge part of the lower side of the diagram 20) may be omitted (cut out). The inclusion relationship is not always unclear because the user can easily estimate the omitted part. By applying such display format, a possession area of a display window can be saved. In this case, it is desired that the omitted part is dynamically adjusted by coupling with an operation of a mouse for a window-bar.

Each class of the hierarchical type database can include an instance. In addition to the above-mentioned inclusion relationship, the hierarchical structure display unit 1 explicitly displays whether each class includes the instance. In a hierarchical structure display of the prior art, an indicator for open and shut of the class is not presented to the user. Briefly, if the user does not open the class from the high level to the low level, the user cannot confirm whether the low level class includes the instance. In the present embodiment, as shown in FIG. 2, an umbrella mark is additionally displayed for each class including a lower level class. Accordingly, the user can confirm whether the class includes the lower level class without operation of open and shut of the class. Furthermore, as shown in FIG. 2, an umbrella mark with black color is additionally displayed for the class including the instance. Accordingly, the user can confirm whether the class includes the instance, and the user can easily retrieve his/her desired class including the instance.

In FIG. 2, the umbrella mark 30 represents existence of the low level class (child class), and the bag marks 32 and 33 represent existence of the instance. A class to which the umbrella mark is not added (for example, “Sedan” class 29 and “Truck” class 25) is the end leaf class which does not include a lower level class.

A closed umbrella mark 31 represents a status that the class hierarchy of lower level is not opened. The closed umbrella mark 31 and an opened umbrella mark 34 are colorless (or white). The colorless represents that the lower level class does not have the instance. For example, “AutoBicycle” class 22 includes the lower level class which is not displayed because the umbrella mark 31 is closed. Furthermore, the “AutoBicycle” class 22 does not include the lower level class having the instance because the umbrella mark 31 is colorless.

The closed and colored umbrella mark 35 represents a status that the class hierarchy of lower level is not opened. The colored mark represents that this class or the lower level class has the instance. Concretely, a “Wagon” class 28 includes the lower level class which is not displayed because the umbrella mark 35 is closed. Furthermore, the “Wagon” class 28 includes the lower level class having the instance because the umbrella mark 35 is colored.

The opened and colorless umbrella mark 34 represents a status that the class hierarchy of lower level is opened and the instance does not exist in this class and the lower level class. For example, a “Sports Car” class 26 includes a “Open Car” class 27 as one lower level class. This umbrella mark 34 is colorless and represents that the instance does not exist in this class and the lower level class.

The opened and colored umbrella class 30 represents a status that the class hierarchy of lower level is opened and the instance exists in this class or the lower level class. For example, the “Vehicle” class 21 includes the “AutoBicycle” class 22 and the “AutoMobile” class 23 as one lower level class. Furthermore, a “Sedan” class 29 and a “Truck” class 25 respectively have the instance. Accordingly, the bag marks 32 and 33 are additionally displayed in each class 29 and 25.

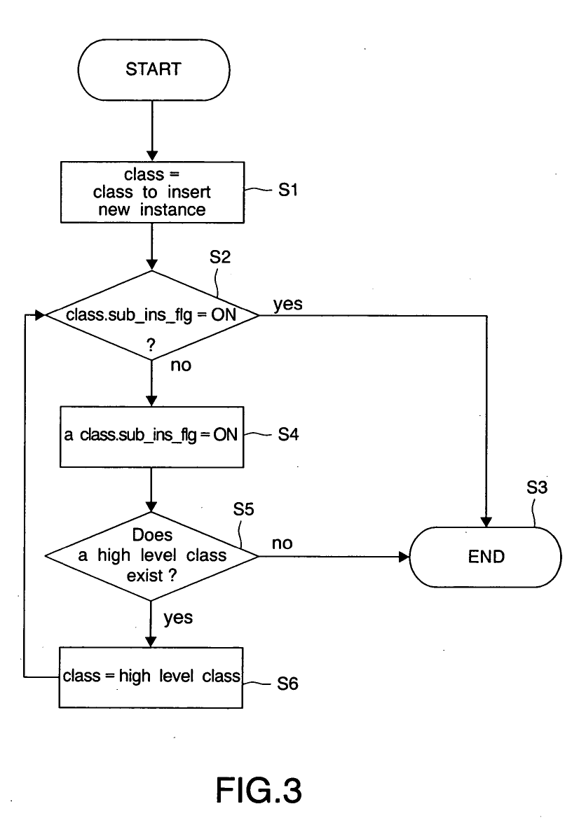

FIG. 3 is a flow chart of processing for a higher level class to decide whether lower level classes have the instance. In the processing step of FIG. 3, as information of each class, a flag representing whether the lower level class has the instance is prepared for each class. This flag is updated whenever the instance is newly created. First, a class in which the instance is newly inserted (created) is set as “class” (S1). As to this class, it is decided whether a flag (sub_ins_flg) is “ON” (S2). In the case of “ON”, a lower level class already has another instance. Accordingly, this processing is completed (S3). In the case of “OFF”, the lower level class does not have another instance yet. Accordingly, this flag is set to “ON” and it is decided whether this class belongs to a higher level class (S5). In the case that the higher level class does not exist, this processing is completed. In the case that the higher level class exists, the higher level class is set as “class” (S6) and processing is returned to step S2. In the processing of FIG. 3, the flag is updated as the minimum limit only when the instance is newly added. Accordingly, this update processing is effective. In the display of class hierarchical structure of FIG. 2, the umbrella mark of a class is colored only if the flag (sub_ins_flg) of the class is “ON”.

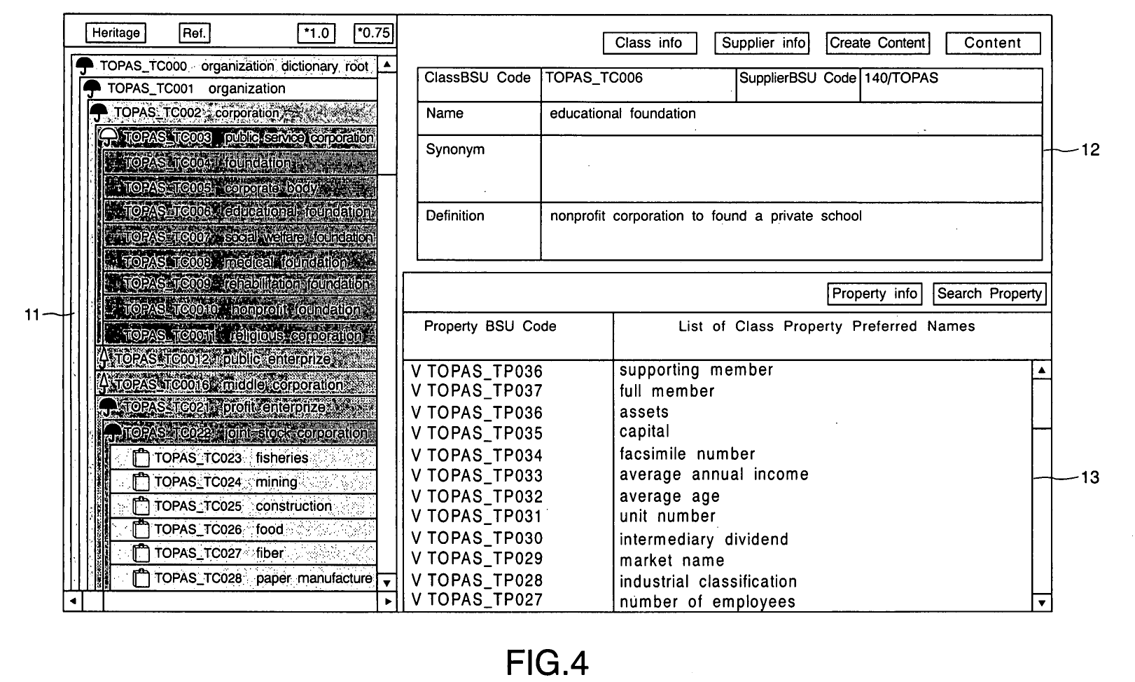

FIG. 4 is a schematic diagram of concrete example of GUI screen related to the hierarchical structure display. In FIG. 4, inclusion relationship between classes is shown in a window area 11. In this area 11, the edge part of the right side of a diagram representing the inclusion relationship between classes is omitted.

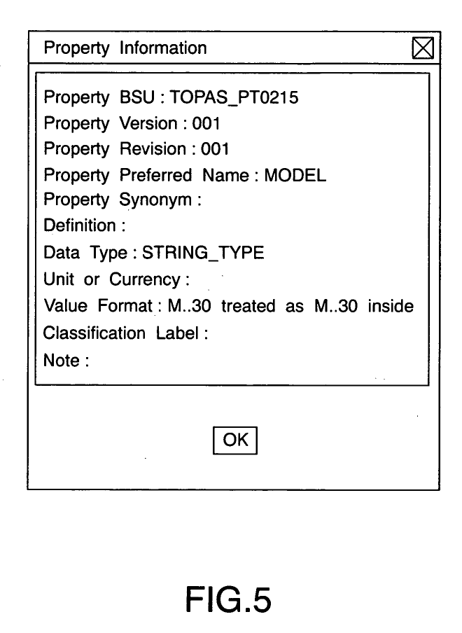

In the hierarchical structure display apparatus of FIG. 1, the hierarchical structure display unit 1 cooperates with the class information display unit 2 and the property list display unit; the property list display unit 3 cooperates with the property information display unit 4; and the display contents change. Information such as a name, a synonym, and a definition of a class selected on the hierarchical structure display unit 1 is confirmatively displayed on the class information display unit 2. This class information display unit 2 corresponds to an area 12 of FIG. 4. Furthermore, a list of properties defined or inherited for the selected class on the hierarchical structure display unit 1 is confirmatively displayed on the property list display unit 3. This property list display unit 3 corresponds to an area 13 of FIG. 4. Furthermore, detail information of the property selected on the property list display unit 3 is confirmatively displayed on the property information display unit 4. FIG. 5 is a schematic diagram of a display example of the detail information on the property information display unit 4. As shown in FIG. 5, the detail information such as a name, a synonym, a definition, and a data type of the property is displayed.

Heritage Display

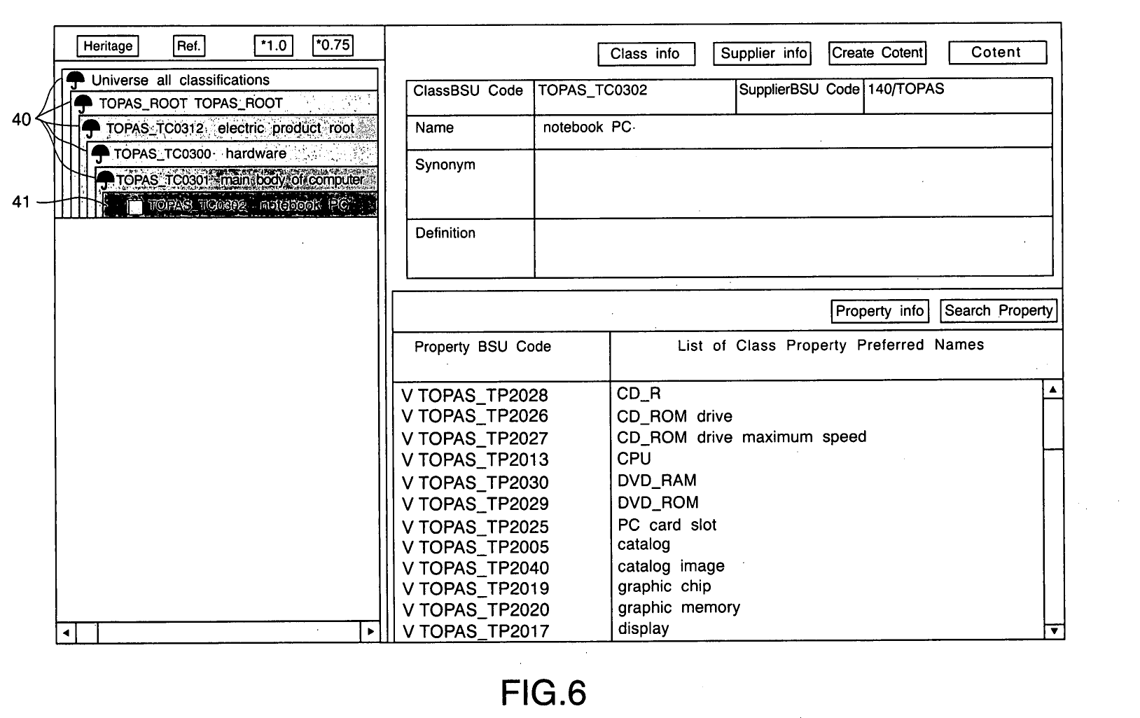

FIG. 6 is a schematic diagram of a display example of a plurality of direct parent classes 40 (higher level classes) from a selected class 41 (low level class). Such display method is called a “heritage display”. In this example, based on a “notebook PC” class 41, a relationship of parent and child among direct classes is shown. For example, whenever a button of the class 41 is pushed, a heritage display and a normal display (including another class of which level is same as the parent class 9 are mutually changed.

Limit of Retrieved Start Point (Traversal Retrieval)

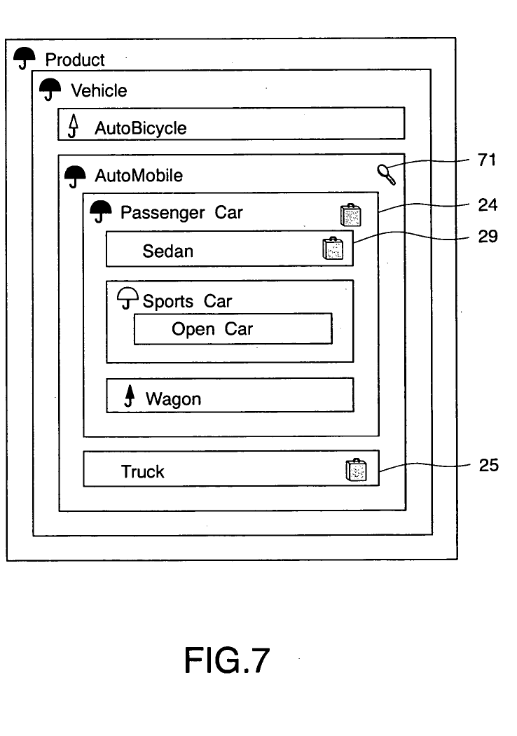

FIG. 7 is a schematic diagram of a display example to explain a “Traversal retrieval” limiting a retrieval start point. In the hierarchical type database, a retrieval of the instance among a plurality of hierarchies (Hereinafter, it is called a “Traversal retrieval”) can be usually executed from an arbitrary class as a start point. In other words, by starting retrieval from a high level hierarchy, the retrieval can be executed without the user's awareness of which class has the instance. However, the higher a hierarchical level of a retrieval start point is, the larger the number of classes and instances as a retrieval object is. As a result, the retrieval time greatly increases and a performance of the system falls. Accordingly, a class to which the retrieval start point sets is limited as shown in FIG. 7. In this case, retrieval for enormous data can be avoided and a fall in the performance of the system can be prevented.

The retrieval start point can be set to the class having the instance. The instance often exists in the class near the end of hierarchical tree (the lowest level class). Accordingly, a number of classes as a retrieval object decreases. In FIG. 7, three classes “Passenger Car” 24, “Sedan” 29 and “Truck” 25 each having the bag mark are set as the Traversal retrieval.

Furthermore, even if a class does not have an instance, if the class includes a lower level class having the instance, a system administrator or a dictionary designer can manually set a retrieval start point to the class by considering a load of the database and the retrieval. In FIG. 7, the class with a colorless umbrella mark such as “AutoBicycle” “Sports Car” and the end class without a bag mark “Open Car” cannot be an object of “Traversal retrieval”. However, other classes can be the object to which the retrieval start point is manually set. The retrieval start point as a mark is explicitly displayed on a diagram of the class to present to the user. In FIG. 7, a magnifying lens mark 71 added to “Automobile” class corresponds to the retrieval start point. In the case of executing the “Traversal retrieval” from “AutoMobile” class, the instance matched with a retrieval condition is retrieved from “Passenger Car” class, “Sedan” class, lower level classes belonging to “Wagon” class and having an instance, and “Truck” class.

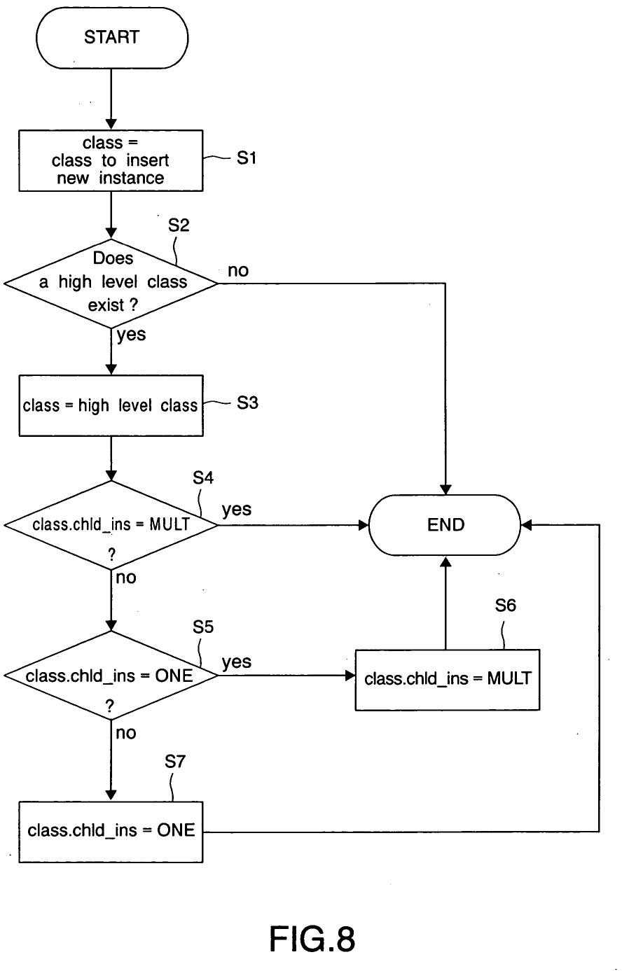

FIG. 8 is a flow chart of processing of automatic set of the retrieval start point. In processing steps of FIG. 8, if a class does not have an instance and includes at least two child classes (one lower level) each having the instance, the retrieval start point is set to this class. For example, the retrieval start point is set at a timing when the instance is inserted to the class. Briefly, as to a class including at least two child classes as one lower level each having the instance, this class is regarded as the retrieval start point. In FIG. 8, “class.chld_ins” of the class is a variable representing whether a child class of one lower level has an instance. An initial value of the variable “class.chld_ins” is set as “NONE” (the child class of one lower level does not have the instance). If one child class of one lower level has the instance, the variable “class.chld_ins” is set as “ONE” (S7). If at least two child classes of one lower level respectively have the instance, the variable “class.chld_ins” is set as “MULT” (S6). As to a class of which variable “class.chld_ins” is “MULT”, the retrieval start point is set to this class. In FIG. 7, “AutoMobile” class includes two child classes “Passenger Car” and “Truck” of one lower level each having the instance. Accordingly, the retrieval start point is set to “AutoMobile” class.

Display of Partial Inheritance

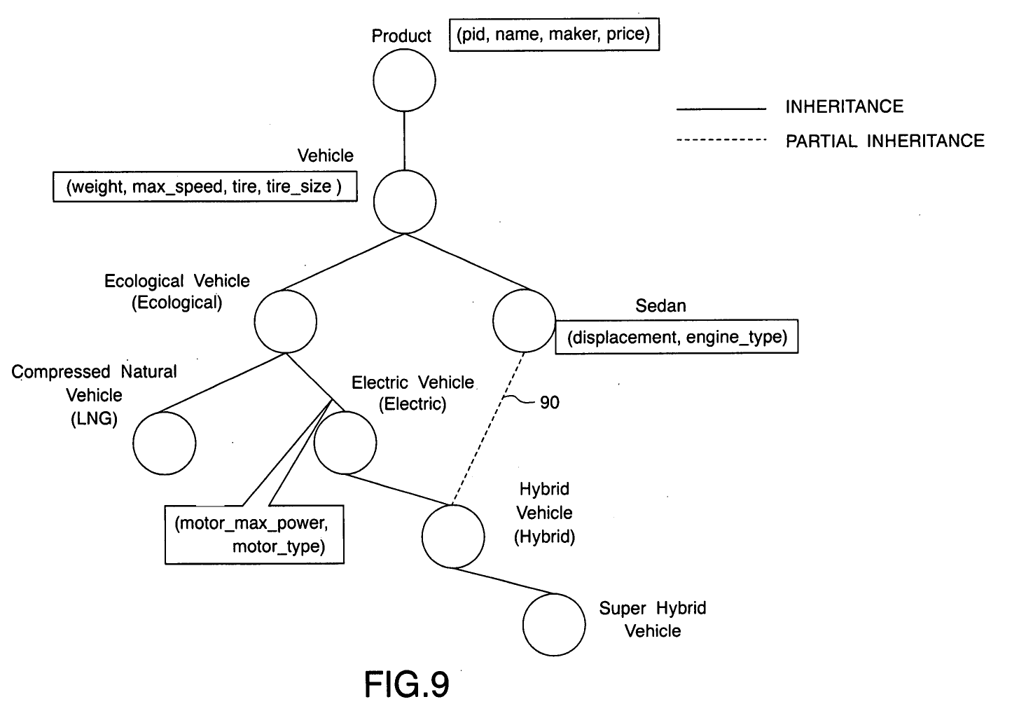

FIG. 9 is one example of a hierarchical structure of a plurality of classes with multiple inheritance. For example, in “ISO 13584”, a hierarchical structure of a simple tree is only prescribed and a multiple inheritance is not prescribed. However, as a similar one of the multiple inheritance, a concept “CaseOf.” which inherits a part of another class is known. This concept means inheritance of a part of property list defined by another class. In hierarchical structure example of FIG. 9, a solid line represents a usual inheritance and a broken line 90 represents a partial inheritance of “CaseOf”. For example, “Hybrid Vehicle” class is a child class of “Electric Vehicle” class and inherits a property of “Sedan” class by a partial inheritance of “CaseOf”.

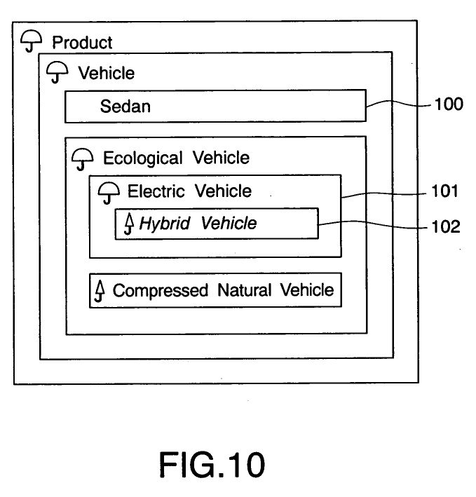

FIG. 10 shows one display example of a partial inheritance of a property in the hierarchical structure. In FIG. 10, “Hybrid Vehicle” class 102 is displayed as a child class of “Electric Vehicle” class 101. In this example, “Sedan” class 100 does not include a child class (lower level class), and it is not clear whether a class having properties partly inherited by “Hybrid Vehicle” class 102 exists. However, in order to point out that “Hybrid Vehicle” class 102 partly inherits a property of another class, the form of characters “Hybrid Vehicle” is oblique which is different from the form of characters of other classes.

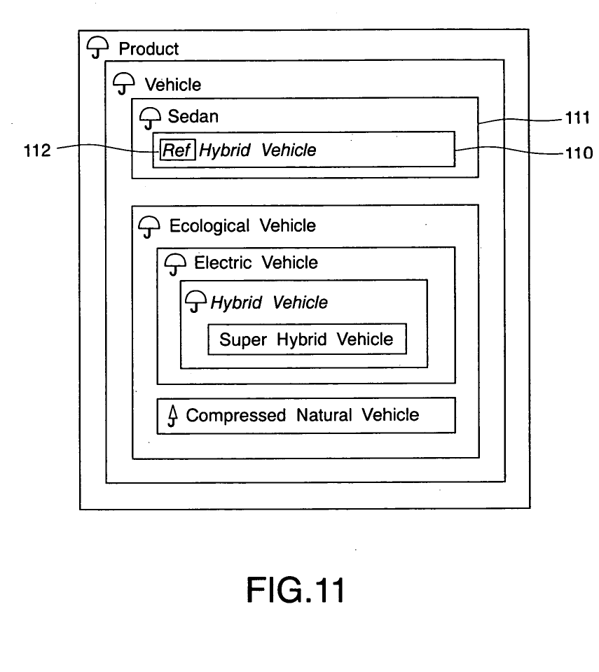

On the other hand, FIG. 11 shows another display example of partial inheritance which is different from FIG 10. In FIG. 11, “Hybrid Vehicle” class 110 is displayed as a child class of “Sedan” class 111. “Hybrid Vehicle” c lass 110 as a lower level class of “Sedan” class 111 is not a regular child class of “Sedan” class 111 but partly inherits a property of “Sedan” class by “CaseOf”. In order to point out the partial inheritance of the property, a reference mark 112 (Ref) is added to “Hybrid Vehicle” class 110. In the case of selecting the class with the reference mark, the hierarchical structure display unit 1 prepares a function to jump to a regular class. Thus, the user can retrieve his/her desired class starting from “Sedan” class 111.

Display of Color Change

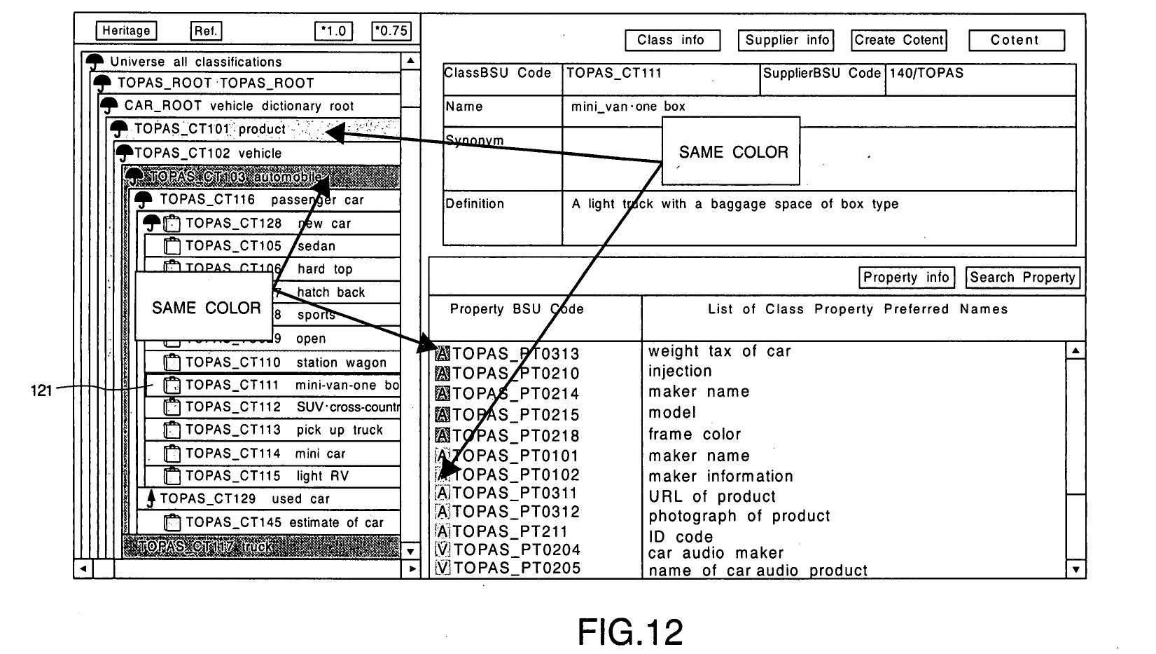

FIG. 12 is a display example of color change for a plurality of classes in hierarchical structure. In FIG. 12, a color of each class on the hierarchical structure display unit 1 is the same as a color of a head mark of a property of the class on the property list display unit 3. By using this display of color change, when a user selects one class 121, the user can confirm which higher level class originally includes each property of the property list included in the one class 121. Briefly, this display method presents a good visual effect to the user.

Reference Display of Source Class of Partial Inheritance

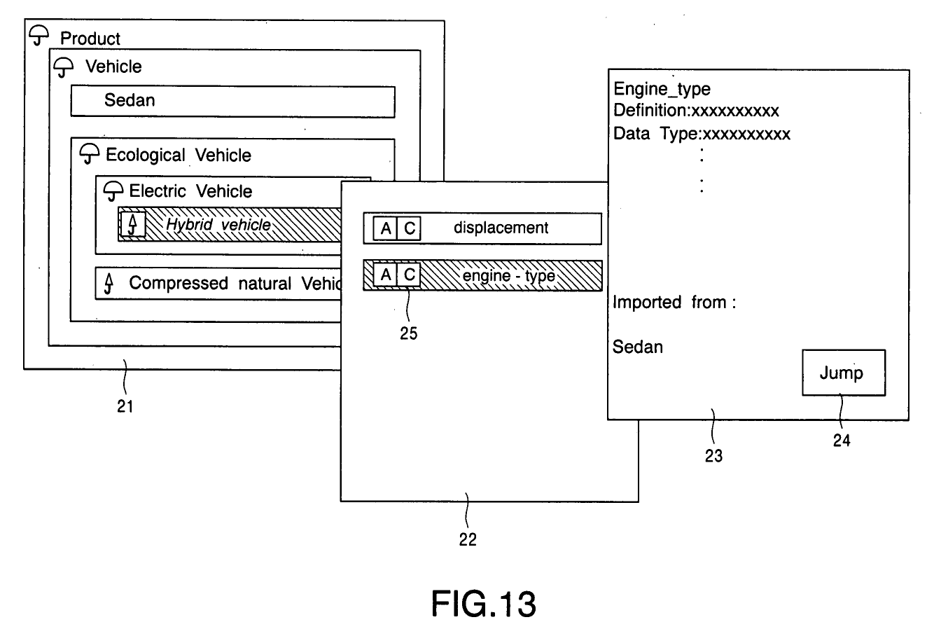

FIG. 13 is an example of reference display of a source class of which property is partly inherited by the selected class (partial inheritance destination class). In FIG. 13, an example of hierarchical structure display 21, an example of property list display 22 and an example of property information display 23, are shown. “Hybrid Vehicle” class in the hierarchical structure display 21 and “engine_type” property in the property list display 22 are items selected by the user and discriminately displayed. Furthermore, C mark 25 at the left edge of the selected property on the property list display 22 is a mark representing that this property is partly inherited from another class. Detail information of “engine type” property which is partly inherited by “Hybrid Vehicle” class is displayed by reference on the property information display 23. By watching this reference display, the user can confirm that the “engine type” property is inherited from “Sedan” class. In this case, when the user pushes a “Jump” button 24, “Sedan” class from which the property is partly inherited is focused (discriminately displayed) on the hierarchical structure display 21. At the same time, a property list of “Sedan” class is newly displayed on the property list display 22.

Display of Virtual Root

The hierarchical structure display unit 1 usually outputs one hierarchical structure. This structure corresponds to a tree derived from a root having no higher level class. In well known graphic library set in “C++” or “Java” language, each of a plurality of trees is displayed by change of a screen. In other words, only one tree is displayed at a time. On the other hand, in one embodiment of the present invention, a virtual root-is set to a plurality of trees, and a class corresponding to the virtual root is created. Accordingly, as each class of one lower level for the virtual root, each root of the plurality of trees is represented.

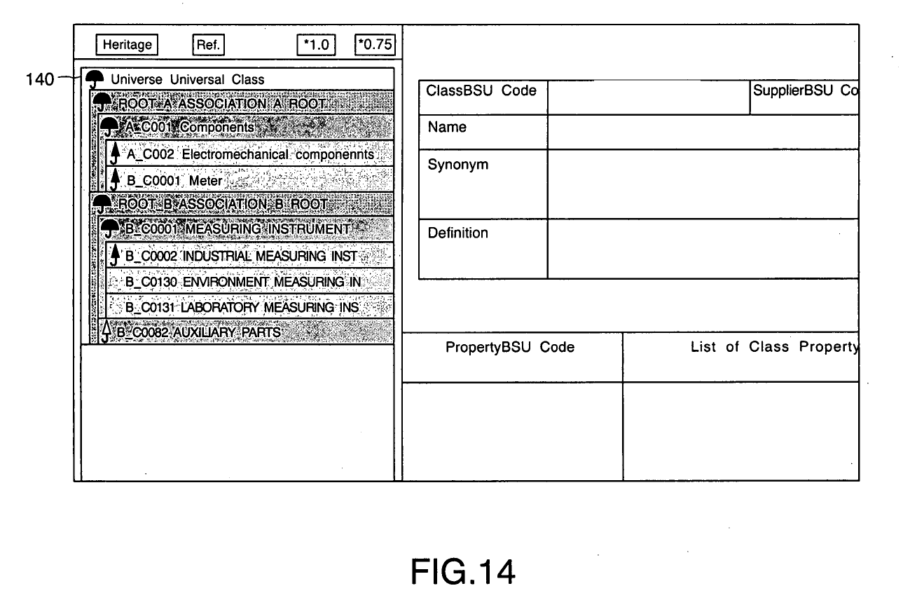

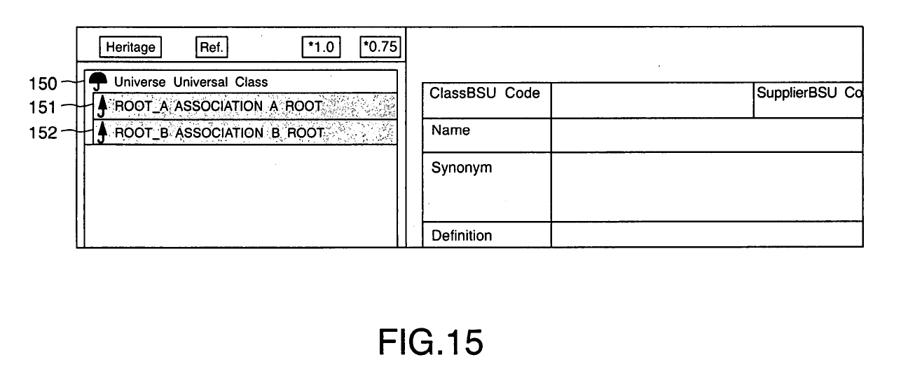

FIG. 14 shows a display example of the virtual root on the hierarchical structure display unit 1. In FIG. 14, the virtual root 140 is operated in the same way as a usual class. Above-mentioned all functions of the present invention can be utilized for the virtual root 140. For example, as shown in FIG. 15, two roots 151 and 152 of each tree as one lower level of the virtual root 150 may be initially displayed.

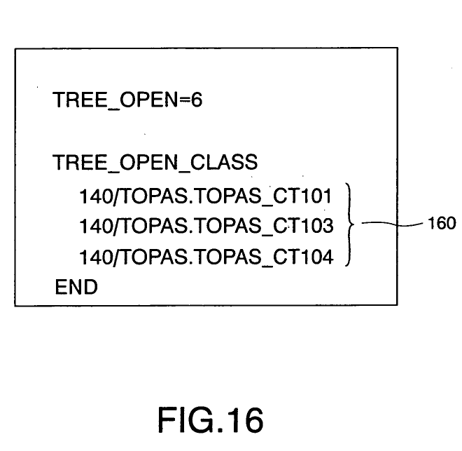

FIG. 16 shows a set example of initial expansion class. In FIG. 16, a number of expansion level as default is set as “TREE_OPEN=6”. Furthermore, each class to be expansively displayed at initial timing can be indicated by listing class identifiers 160 following “TREE_OPEN_CLASS”. Expansion of a class is based on the number of default expansion levels in principle. However, in the case of indicating each class to be displayed, each class is expansively displayed for a corresponding branch part in the tree.

As mentioned-above, in one embodiment of the present invention, in addition to inclusion relationship of the hierarchical structure, class information such as existence of the instance and the property list, and property information, are effectively displayed. Accordingly, an interface for the user to easily operate can be presented. For example, the user or a presenter can intentionally indicate a limit of classes to be hierarchically displayed. In this case, only a necessary part of a complicated hierarchical structure can be only presented to the user. Furthermore, a retrieval start point is limited and presented to the user. In this case, retrieval with a lower system load can be executed.

The present invention is not limited to the above-mentioned embodiments and cam be variously transformed. For example, the present invention can be applied to not only the hierarchical type database including inheritance of properties for classes but also display of hierarchical structure for various systems. Concretely, the present invention can be applied to a display of directory structure tree in a file system. In this case, existence or non-existence of the instance is explicitly displayed for each directly.

As mentioned above, in the hierarchical structure display apparatus and display of the present invention, inclusion relationship between classes in the hierarchical type database can be properly and effectively displayed.

For embodiments of the present invention, the processing of the present invention can be accomplished by a computer-executable program, and this program can be realized in a computer-readable memory device.

In embodiments of the present invention, the memory device, such as a magnetic disk, a floppy disk, a hard disk, an optical disk (CD-ROM, CD-R, DVD, and so on), an optical magnetic disk (MD and so on) can be used to store instructions for causing a processor or a computer to perform the processes described above.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device. The component of the device may be arbitrarily composed.

In embodiments of the present invention, the computer executes each processing stage of the embodiments according to the program stored in the memory device. The computer may be one apparatus such as a personal computer or a system in which a plurality of processing apparatuses are connected through a network. Furthermore, in the present invention, the computer is not limited to a personal computer. Those skilled in the art will appreciate that a computer includes a processing unit in an information processor, a microcomputer, and so on. In short, the equipment and the apparatus that can execute the functions in embodiments of the present invention using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. An apparatus for displaying a hierarchical structure, comprising:
a memory configured to store a database for a plurality of classes having a hierarchical structure; and
a display configured to output at least part of a first area of one class and at least part of a second area of at least one child class belonging to the one class, the one class and the at least one child class being defined in the plurality of classes, and the first area including the second area.

2. The apparatus according to claim 1,
wherein said display outputs all of the first area including all of the second area.

3. The apparatus according to claim 1,
wherein said display outputs class information related to the one class or the at least one child class.

4. The apparatus according to claim 3,
wherein said display outputs a list of properties included in the one class or the at least one child class.

5. The apparatus according to claim 4,
wherein said display outputs property information related to one property from the list of properties.

6. The apparatus according to claim 1,
wherein said display outputs a mark in correspondence with each class of the first area and the second area, and
wherein the mark represents that a corresponding class hierarchically includes a child class.

7. The apparatus according to claim 6, further comprising:
an operation unit configured to indicate whether an area of the child class is displayed in an area of the corresponding class.

8. The apparatus according to claim 7,
wherein a status of the mark of the corresponding class of which the area of the child class is displayed is different from a status of the mark of the corresponding class of which the area of the child class is not displayed.

9. The apparatus according to claim 8,
wherein a status of the mark of the corresponding class of which the child class has an instance is different from a status of the mark of the corresponding class of which the child class does not have an instance.

10. The apparatus according to claim 9,
wherein said display outputs another mark in corresponding with the child class which has the instance.

11. The apparatus according to claim 7,
wherein said operation unit selects a class to display direct classes from the plurality of classes,
wherein said display outputs the direct classes to which the class belongs.

12. The apparatus according to claim 7,
wherein said operation unit sets a universal root class commonly including a first hierarchical structure derived from a first root class and a second hierarchical structure derived from a second root class.

13. The apparatus according to claim 7,
wherein said operation unit sets a retrieval start point to the one class of the first area on said display, and
wherein a retrieval object is limited to the child class having the instance.

14. The apparatus according to claim 13,
wherein said operation unit seta the retrieval start point to a class including at least two child classes each having an instance.

15. The apparatus according to claim 5,
wherein the child class inherits at least one property of each of a plurality of parent classes in the plurality of classes stored in said memory.

16. The apparatus according to claim 15,
wherein a display status of the child class inheriting at least one property of each of the plurality of parent classes is different from a display status of another child class not inheriting at least one property of each of the plurality of parent classes.

17. The apparatus according to claim 16,
wherein said operation unit indicates a reference of an inheritance source class of one property of the child class inheriting at least one property of each of the plurality of parent classes, and
wherein the inheritance source class is one of the plurality of parent classes.

18. The apparatus according to claim 5,
wherein a color of a property in the list of properties of the child class as an inheritance destination class is the same as a color of the parent class having the property as the inheritance source class.

19. The apparatus according to claim 1,
wherein said operation unit sets a number of hierarchical levels for a plurality of classes at an initialization mode to display the hierarchical structure of the plurality of classes.

20. The apparatus according to claim 19,
wherein said operation unit sets an identifier of each class to be expansibly displayed in the plurality of classes at the initialization mode.

21. A method for displaying a hierarchical structure, comprising:
storing a database for a plurality of classes having a hierarchical structure; and
displaying at least part of a first area of one class and at least part of a second area of at least one child class belonging to the one class, the one class and the at least one child class being defined in the plurality of classes, and the first area including the second area.

22. A computer program product, comprising:
a computer readable program code embodied in said product for causing a computer to display a hierarchical structure, said computer readable program code comprising:
a first program code to store a database for a plurality of classes having a hierarchical structure; and
a second program code to display at least part of a first area of one class and at least part of a second area of at least one child class belonging to the one class, the one class and the at least one child class being defined in the plurality of classes, and the first area including the second area.
